(19) United States
(12) Patent Application Publication
(10) Pub. No.: US 2007/0264072 A1
(43) Pub. Date: Nov. 15, 2007

(54) Keyboard with anti-bacteria surface

(75) Inventor: Peter Chen, Taipei (TW)

Correspondence Address: BACON & THOMAS, PLLC, 625 SLATERS LANE, FOURTH FLOOR, ALEXANDRIA, VA, 22314, US

(73) Assignee: KEY MOUSE ELECTRONIC ENTERPRISE CO., LTD., Taipei County (TW)

(21) Appl. No.: 11/431,597

(22) Filed: May 11, 2006

(51) Int. Cl. G06F 3/023

(52) U.S. Cl. 400/472

(57) ABSTRACT

A keyboard (or keypad) includes a top surface formed with a transparent anti-bacteria layer of titanium crystals which is formed by coating a titanium dioxide (TiO₂) on the top surface in a nano process at a very low temperature whereby exposing the top surface to light rays will kill bacteria or viruses grown or adhered on the top surface through a photoactinic effect. Preferably, the titanium crystal has a diameter of about 20 nm.

### BACKGROUND OF THE INVENTION

1. Field of Invention

The present invention relates to keyboards and more particularly to a keyboard (or keypad) having its top surface formed with an anti-bacteria layer of titanium crystals such that bacteria or viruses grown on the top surface or gaps between keys can be killed when the keyboard (or keypad) is exposed to light rays through the photoactinic effect.

2. Related Art

A conventional keyboard is made of ABS (acrylonitrile-butadiene-styrene). It is also understood that a keyboard, as an input device of a desktop computer or notebook computer, is often in contact with the human hands. Thus, sweat, dirt, or other foreign objects may stay on a top surface or gaps between keys of the keyboard. As such, bacteria or viruses may grow on the top surface or the gaps between keys. It is thus highly possible that a frequent computer user may be infected due to long time keyboard contact.

Taiwanese Utility Model Patent Application No. 093,211,726 discloses a keyboard inside installed with a LED light as a source for emitting UV to its top surface. However, so far as the present inventor is aware, the prior art keyboards have had no market acceptance due to poor anti-bacteria capability. Thus, there still need a keyboard exhibiting better anti-bacteria effect.

### SUMMARY OF THE INVENTION

It is therefore an object of the present invention to provide a keyboard comprising a top surface formed with a transparent anti-bacteria layer of titanium crystals which is formed by coating a titanium dioxide (TiO₂) on the top surface in a nano process whereby exposing the top surface to light rays will kill bacteria or viruses grown or adhered on the top surface through a photoactinic effect.

In one aspect of the present invention the titanium crystal has a diameter of about 20 nm.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of keyboard according to the invention; and

FIG. 2 is a sectional view of the top surface of the keyboard.

### DETAILED DESCRIPTION OF THE INVENTION

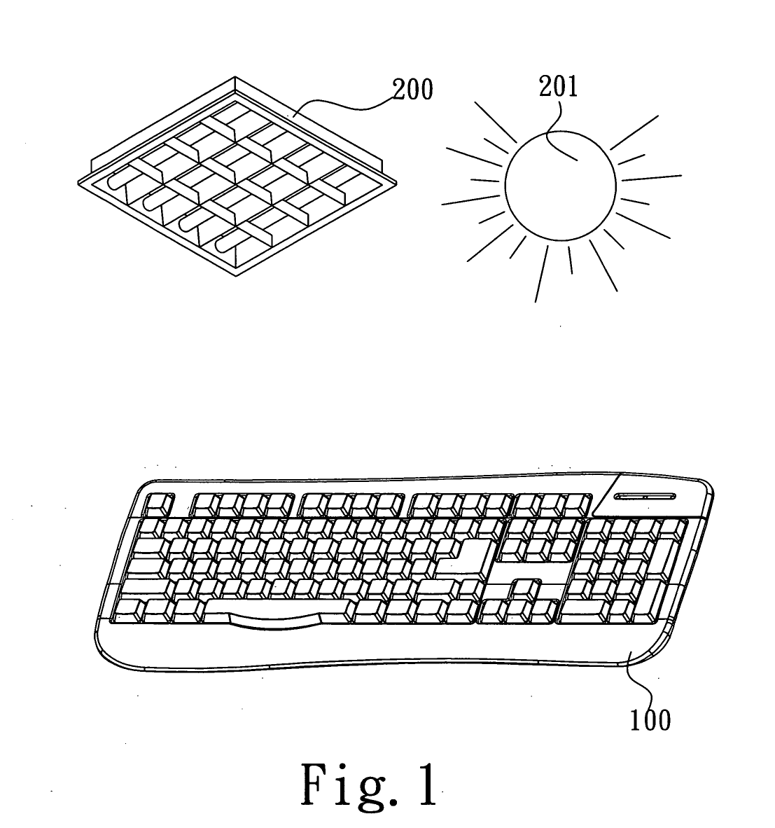

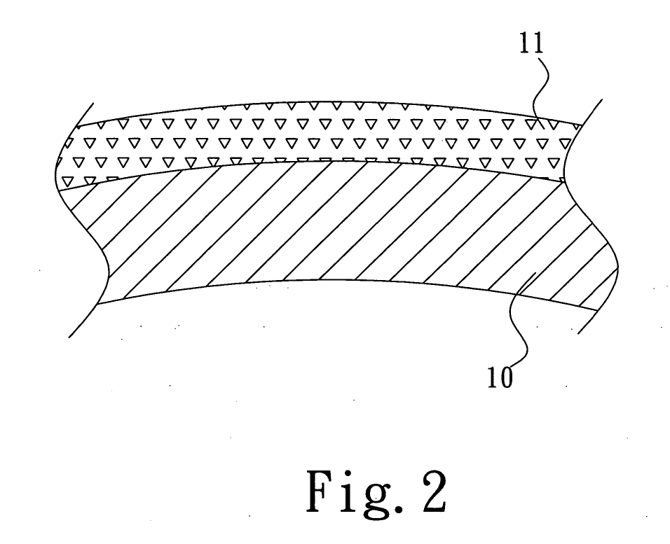

Referring to FIGS. 1 and 2, an input device in accordance with a preferred embodiment of the invention is shown. The input device is implemented as a keyboard 100 (as shown) such as a keyboard of a desktop computer or notebook computer. Alternatively, the input device is implemented as a keypad such as a keypad of a mobile phone or PDA (Personal Digital Assistant).

A top surface 10 of the keyboard 100 is formed with a transparent anti-bacteria layer 11 of titanium crystals. The transparent layer 11 is capable of preserving an aesthetic appearance of the keyboard 100. The anti-bacteria layer 11 of titanium crystals is formed by coating a titanium dioxide (TiO₂) on the top surface 10 in a nano process at a very low temperature. Preferably, a diameter of the titanium crystal is about 20 nm. Electrons and holes are generated on a surface of the titanium crystals when the top surface 10 is exposed to sunlight 201 or light emitted by fluorescent lamps 200. A minimum current may be generated when the electrons flow to the holes. The current then reacts with hydrogen and oxygen molecules to generate active oxygen radicals which are capable of disconnecting bonds between molecules of an organic compound. As such, the organic compound is decomposed. As an end, effects including killing bacteria or viruses grown or adhered on the top surface 10 or gaps between keys, deodorizing air, decomposing hazardous substances around the keyboard 100, or the like are achieved.

In brief, photoactinic effect for killing bacteria or viruses is produced on the keyboard 100 when light is impinged on the anti-bacteria layer 11 of titanium crystals on its top surface 10.

While the invention herein disclosed has been described by means of specific embodiments, numerous modifications and variations could be made thereto by those skilled in the art without departing from the scope and spirit of the invention set forth in the claims.

What is claimed is:

1. A keyboard comprising a top surface formed with a transparent anti-bacteria layer of titanium crystals which is formed by coating a titanium dioxide (TiO₂) on the top surface in a nano process whereby exposing the top surface to light rays will kill bacteria or viruses grown or adhered on the top surface through a photoactinic effect.

2. The keyboard of claim 1, wherein the titanium crystal has a diameter of about 20 nm.
